(19) United States
(12) Patent Application Publication
(10) Pub. No.: US 2009/0089461 A1
(43) Pub. Date: Apr. 2, 2009

(54) Image input/output switching method for a notebook computer and related notebook computer

(75) Inventors: Chieh-Yao Hsiao, Taipei Hsien (TW); Yan-Ling Chen, Taipei Hsien (TW); Shi-Youn Dong, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: Wistron Corporation, Taipei Hsien (TW)

(21) Appl. No.: 12/153,548

(22) Filed: May 21, 2008

(30) Foreign Application Priority Data
Oct. 2, 2007 (TW) 096136963

(51) Int. Cl. G06F 3/00

(52) U.S. Cl. 710/15

(57) ABSTRACT

A notebook computer includes a display module, a processing unit, an image input/output module and a detecting unit. The processing unit is electrically connected to the display module. The image input/output module is electrically connected to the processing unit and includes an image switch and at least one image connector. The detecting unit is electrically connected to the display module and the image input/output module. The detecting unit is capable of detecting whether a signal transmitted via the image input/output module is an input or output signal, and notifies the display module and the image input/output module accordingly to switch to the input/output image.

### BACKGROUND OF THE INVENTION

1. Field of the Invention

The present invention relates an image input/output switching method for a notebook computer and related notebook computer and, more particularly, to an automatic or manual image input/output switching method for a notebook computer and related notebook computer, which is capable of displaying image information from an external device on a display screen of the notebook computer.

2. Description of the Related Art

With technological improvements, various multimedia electronic devices are used for the dynamic or static presentation of information for different occasions. For example, notebook computers are some of the most popular multimedia electronic devices due to their portability and flexibility with regards to being connectable with other external projecting devices for presentation purposes. However, on some occasions, if there is no external display device and the notebook computer only has a video output interface and is unable to support the display of external video, the user will be unable to make the presentation.

It is therefore desirable to provide an image input/output switching method for a notebook computer and a related notebook computer to mitigate and/or obviate the aforementioned problems.

### SUMMARY OF THE INVENTION

A main objective of the present invention is to provide a notebook computer capable of image input/output switching so a user can use a display screen of the notebook computer to display image information from an external device.

Another objective of the present invention is to provide an image input/output switching method for a notebook computer.

In order to achieve the above mentioned objective, a notebook computer includes a display module, a processing unit, an image input/output module and a detecting unit. The processing unit is electrically connected to the display module. The image input/output module is electrically connected to the processing unit and includes an image switch and at least one image connector. The detecting unit comprises a control unit and is electrically connected to the display module and the image input/output module. The detecting unit is capable of detecting whether a signal transmitted via the image input/output module is an input or output signal, and notifies the display module and the image input/output module accordingly to switch to the input/output image. The notebook computer is informed automatically or manually to perform the image output/input switching without complicated switch settings to provide improved convenience by the notebook computer for the user.

In order to achieve the above mentioned another objective, an image input/output switching method for a notebook compute comprises: connecting an external device to the image input/output module so the external device is electrically connected to the notebook computer; using the detecting unit to determine whether a signal sent from the image input/output module is an output or input signal; and using the detecting unit to notify the display module and the image input/output module to switch the input/output image.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of a notebook computer capable of image output/input switching according to the present invention.

FIG. 2 is a schematic drawing of a first embodiment of a notebook computer capable of image output/input switching according to the present invention.

FIG. 3 is a schematic drawing of a second embodiment of a notebook computer capable of image output/input switching according to the present invention.

FIG. 4 is a schematic drawing of a third embodiment of a notebook computer capable of image output/input switching according to the present invention.

FIG. 5 is a schematic drawing of a fourth embodiment of a notebook computer capable of image output/input switching according to the present invention.

FIG. 6 is a flowchart of an image input/output switching method for a notebook computer according to the present invention.

### DETAILED DESCRIPTION OF THE PREFERRED EMBODIMENT

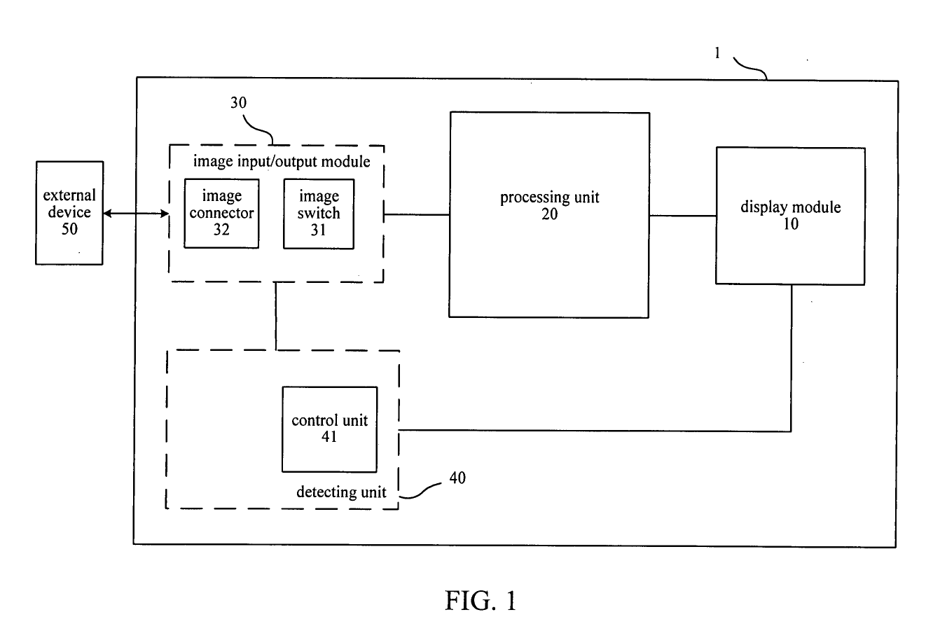

Please refer to FIG. 1. FIG. 1 is a schematic drawing of a notebook computer capable of image output/input switching according to the present invention. As shown in FIG. 1, a notebook computer 1 capable of image output/input switching comprises a display module 10, a processing unit 20, an image input/output module 30 and a detecting unit 40. The processing unit 20 is electrically connected to the display module 10, and the image input/output module 30 is electrically connected to the processing unit 20. The image input/output module 30 comprises an image switch 31 and at least one image connector 32, and the detecting unit 40 is electrically connected to the display module 10 and the image input/output module 30. The detecting unit 40 comprises a control unit 41. The control unit 41 can be a south bridge chip or a keyboard controller. When an external device 50 is electrically connected to the image input/output module 30, the detecting unit 40 can receive a signal sent from the external device 50 and determine whether the signal is an output or input signal to notify the display module 10 and the image input/output module 30 to switch the input/output image by sending out a corresponding signal.

The detecting unit 40 of the notebook computer 1 can determine whether the signal is an output or input signal by detecting the connection status between the image input/output module 30 and the external device 50. In this embodiment, an image input converter with special pins (not shown) is added to the notebook computer 1. One end of the image input converter is connected to the external device 50, and the other end is connected to the image connector 32 of the image input/output module 30. When the image input converter is connected to the image connector 32, the design of the pins (the number of pins or the number of grounded pins) causes the image input converter to generate signals different from standard image output devices, and the control unit 41 detects this signal and informs the display module 10 and the image input/output module 30 to perform image input switching.

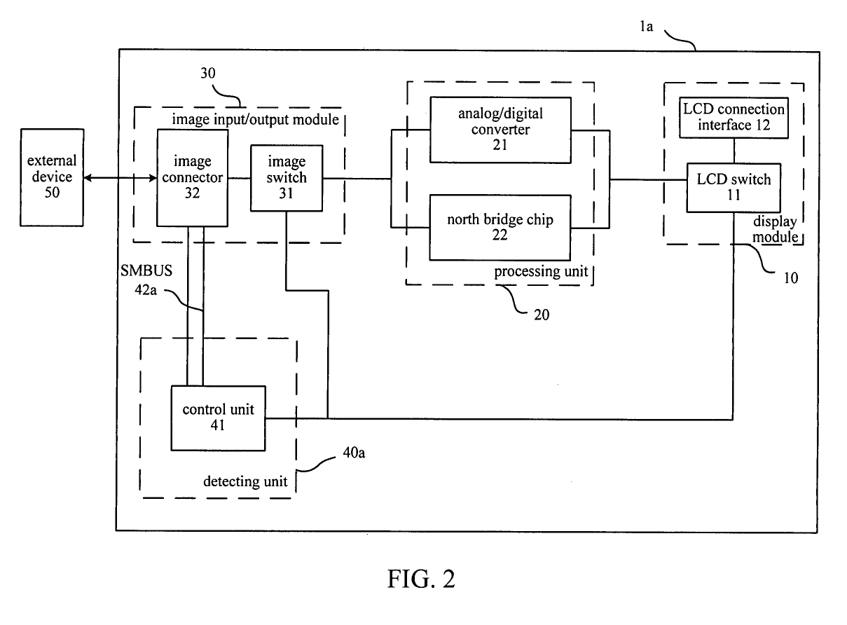

Please refer to FIG. 2. FIG. 2 is a schematic drawing of a first embodiment notebook computer capable of image output/input switching according to the present invention. As shown in FIG. 2, the display module 10 of the notebook computer 1a comprises an LCD switch 11 and an LCD connection interface 12. The LCD connection interface 12 is connected to a display screen (not shown) of the notebook computer 1. The processing unit 20 comprises an analog/digital converter 21 and a north bridge chip 22. In this embodiment, the detecting unit 40a is electrically connected to the image connector 32 of the image input/output module 30 via an SMBUS (system manage BUS) 42a. When the external device 50 is electrically connected to the image connector 32, the SMBUS 42a changes its state according to the signal sent from the external device 50 depending on whether it is an output or input signal. When the external device 50 performs image input, the SMBUS 42a enters a master state, and the control unit 41 receives this state change and sends out a signal to inform the LCD switch 11 and the image switch 31 to switch to an image input mode. The image input signal sent from the external device 50 is thus sent to the analog/digital converter 21 via the image switch 31 to perform the signal switching. The switched signal is sent from the LCD switch 11 to the LCD connection interface 12 to display the image information on the display screen. Alternatively, when the external device 50 performs image output, the SMBUS 42a enters a slave state, and the control unit 41 receives this state change and sends out a signal to inform the LCD switch 11 and the image switch 31 to switch to an image output mode. Therefore, the image information of the notebook computer 1 is sent from the north bridge 22 to the image connector 32 via the image switch 31 to display the image information on the external device 50. With this design, after the external device 50 is connected to the image input/output module 30 of the notebook computer 1, it automatically detects and switches image output or input for improved convenience.

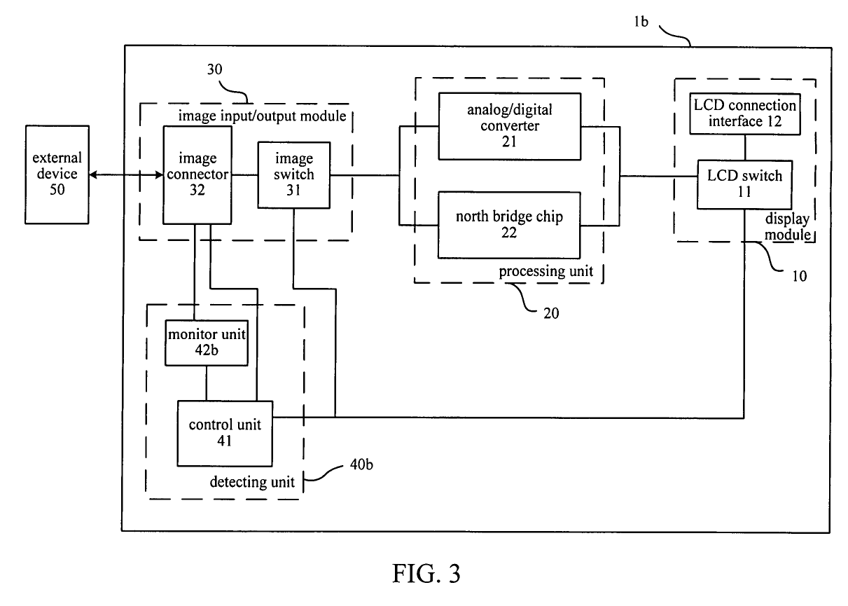

Please refer to FIG. 3. FIG. 3 is a schematic drawing of a second embodiment notebook computer capable of image output/input switching according to the present invention. As shown in FIG. 3, the notebook computer 1b is a variation of the first embodiment. The detecting unit 40b determines whether the sent signal is an output or input signal by detecting the current direction of the image input/output module 30. In this embodiment, the detecting unit 40b further comprises a monitor unit (monitor IC) 42b, and the monitor unit 42b is electrically connected to the control unit 41 and the image connector 32 of the image input/output module 30. When the external device 50 is connected to the image connector 32, since the current direction of the signal changes depending on whether the external device 50 performs image input or output, the monitor unit 42b receives a signal passing through the image connector 32 to determine the current direction, and sends the result to the control unit 41. Then, the control unit 41 informs the LCD switch 11 and the image switch 31 to perform the image input/output switching.

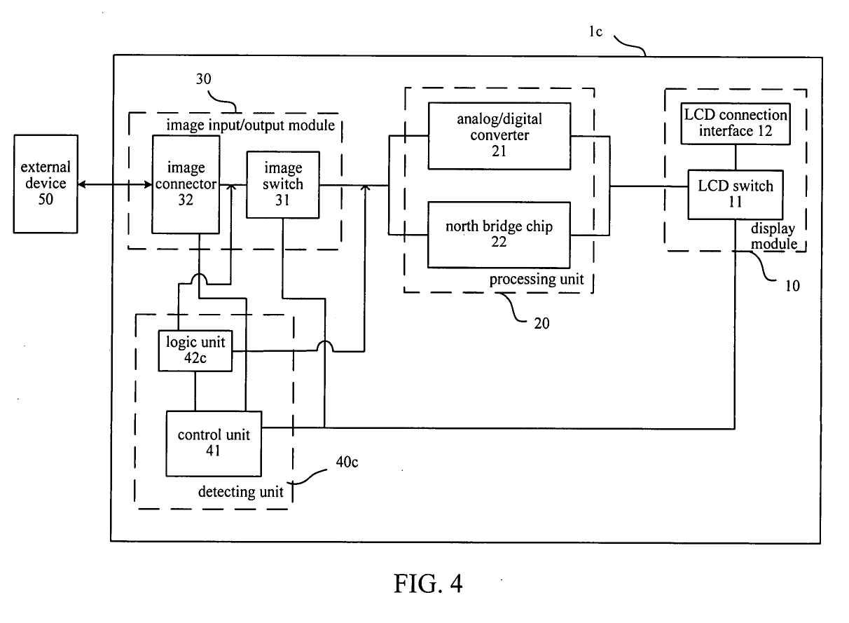

Please refer to FIG. 4. FIG. 4 is a schematic drawing of a third embodiment notebook computer capable of image output/input switching according to the present invention. As shown in FIG. 4, a notebook computer 1c is a variation of the first embodiment, wherein a detecting unit 40c determines whether the sent signal is an output or input signal by detecting the state of the H/V sync of the signal. In this embodiment, the detecting unit 40c further comprises a logic unit 42c, and the logic unit 42c is electrically connected to the processing unit 20, the control unit 41 and the image input/output module 30. When the external device 50 is connected to the image connector 32, the logic unit 42c detects the state of the H/V sync of the signals close to the image connector 32 and the north bridge chip 22. When the external device 50 performs image input, the logic unit 42c detects that the H/V sync of the signals close to the image connector 32 and the north bridge chip 22 have jumped, and sends this determination result to the control unit 41. Then, the control unit 41 informs the LCD switch 11 and the image switch 31 to perform the image input/output switching. Alternatively, when the external device 50 performs image output, the logic unit 42c detects that the H/V sync of the signal close to only the north bridge chip 22 has jumped; the control unit 41 informs the LCD switch 11 and the image switch 31 to perform the image input/output switching.

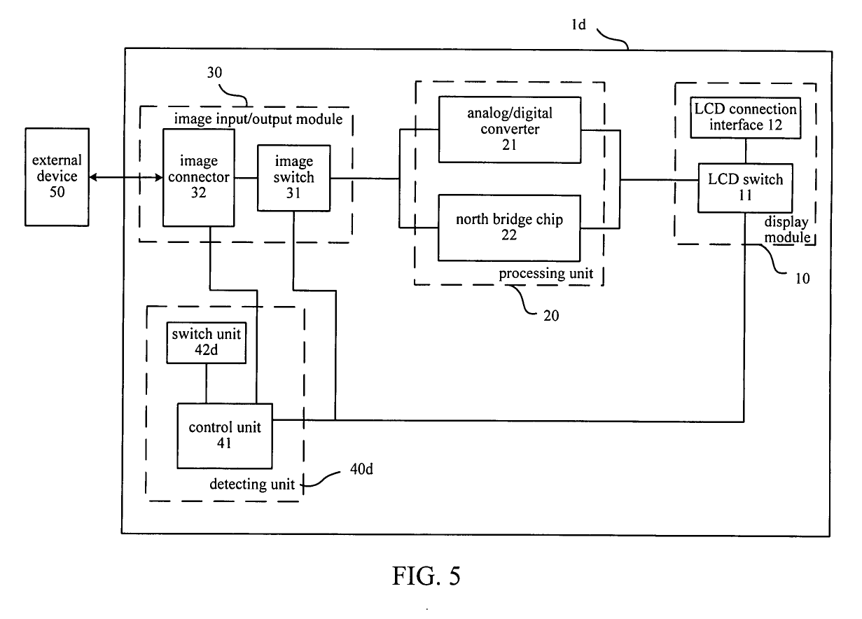

Please refer to FIG. 5. FIG. 5 is a schematic drawing of a fourth embodiment notebook computer capable of image output/input switching according to the present invention. As shown in FIG. 5, a notebook computer 1d is a variation of the first embodiment. In this embodiment, a detecting unit 40d further comprises a switch unit 42d, and the switch unit 42d is electrically connected to the control unit 41. The switch unit 42d can be manually controlled to perform image input/output switching. Normally, the image input/output module 30 of the notebook computer 1d is preset to the image output mode, and when the user wants to connect the external device 50 to perform image inputting, he or she needs to manually control the switch unit 42d to generate a signal that is sent to the control unit 41. If the control unit 41 receive the signal and also detects the external device 50 is connected to the image input/output module 30, the control unit 41 informs the LCD switch 11 and the image switch 31 to perform image input switching. In this embodiment, the switch unit 42d can be an independent switch, a keyboard button, or a set of keyboard buttons. The image input/output module 30 of the notebook computer 1d further comprises two image connectors 32, with one respectively supporting an image input mode and that other an image output mode and utilizes the switch unit 42d to switch the input/output image.

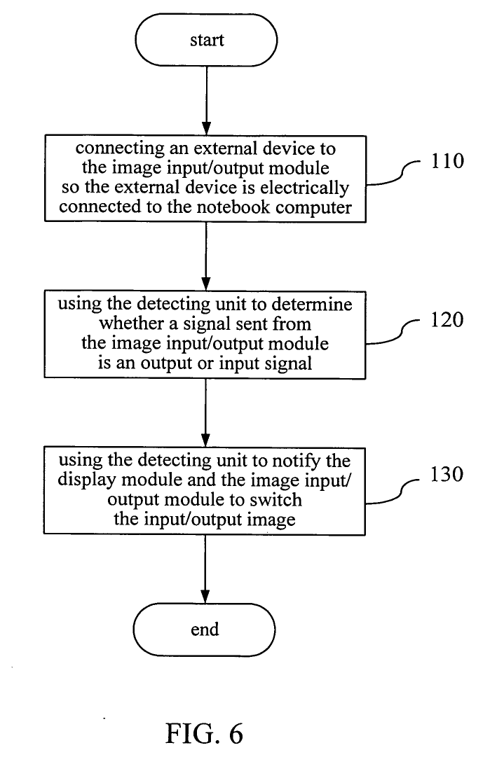

Please refer to FIG. 6. FIG. 6 is a flowchart of an image input/output switching method for a notebook computer according to the present invention. As shown in FIG. 6, an image input/output switching method for a notebook computer comprises:

Step 110: connecting an external device and the image input/output module together to electrically connect the external device to the notebook computer. As shown in FIG. 1, the notebook computer 1 comprises the image input/output module 30, the detecting unit 40, the processing unit 20 and the display module 10, and the detecting unit 40 comprises the control unit 41. The external device 50 is electrically connected to the notebook computer 1 via the image input/output module 30.

Step 120: using the detecting unit determines whether a signal sent from the image input/output module to the external device is an output or input signal. When the external device 50 is electrically connected to the image input/output module 30, a signal is generated, and the detecting unit 40 analyzes this signal to determine whether the signal is an input or output signal. The detecting unit 40 utilizes the above-mentioned different circuit design to detect the different characteristics of input and output signals.

Step 130: using the detecting unit to notify the display module and the image input/output module to switch the input/output image. After the detecting unit 40 determines whether the signal is an input or output signal, it informs the display module 10 and the image input/output module 30 to switch the input/output image, so the notebook computer 1 enters into the image output or input mode.

With the above-mentioned designs, the image input/output switching method for the notebook computer may be applied to any of the previously mentioned embodiments; after the external device 50 is electrically connected to the notebook computer 1, the notebook computer 1 is informed automatically or manually to perform the image output/input switching without complicated switch settings to provide improved convenience by the notebook computer 1 for the user.

Although the present invention has been explained in relation to its preferred embodiment, it is to be understood that many other possible modifications and variations can be made without departing from the spirit and scope of the invention as hereinafter claimed.

What is claimed is:

1. A notebook computer capable of image input/output switching comprising:
a display module;
a processing unit electrically connected to the display module;
an image input/output module electrically connected to the processing unit, the image input/output module having an image switch and at least one image connector; and
a detecting unit electrically connected to the display module and the image input/output module, the detecting unit having a control unit, wherein the detecting unit determines whether a signal sent by the image input/output module is an output or input signal, and notifies the display module and the image input/output module to switch the input/output image.

2. The notebook computer as claimed in claim 1, wherein the detecting unit detects a state of an SMBUS (system management BUS) to determine whether the signal is an output or input signal.

3. The notebook computer as claimed in claim 1, wherein the detecting unit detects a current direction passing the image input/output module to determine whether the signal is an output or input signal.

4. The notebook computer as claimed in claim 1, wherein the detecting unit further comprises a monitor unit, the monitor unit electrically connected to the control unit and the image input/output module.

5. The notebook computer as claimed in claim 1, wherein the detecting unit detects a state of an H/V sync of the signal to determine whether the signal is an output or input signal.

6. The notebook computer as claimed in claim 1, wherein the detecting unit further comprises a logic unit, the logic unit electrically connected to the processing unit, the control unit and the image input/output module.

7. The notebook computer as claimed in claim 1, wherein the detecting unit further comprises a switch unit, the switch unit electrically connected to the control unit and used for switching to the input/output image.

8. The notebook computer as claimed in claim 7, wherein the switch unit is an independent switch, a keyboard button, or a set of keyboard buttons.

9. The notebook computer as claimed in claim 1, wherein the detecting unit detects a connection status between the image input/output module and an external device to determine whether the signal is an output or input signal.

10. The notebook computer as claimed in claim 1, wherein the control unit is a south bridge chip or a keyboard controller.

11. The notebook computer as claimed in claim 1, wherein the image input/output module comprises two image connectors.

12. An image input/output switching method for a notebook computer, the notebook computer comprising a image input/output module, a detecting unit, a processing unit and a display module, the detecting unit comprising a control unit, the method comprising:
connecting an external device to the image input/output module so the external device is electrically connected to the notebook computer;
using the detecting unit to determine whether a signal sent from the image input/output module is an output or input signal; and
using the detecting unit to notify the display module and the image input/output module to switch the input/output image.

13. The method as claimed in claim 12, wherein the detecting unit detects a state of an SMBUS (system management BUS) to determine whether the signal is an output or input signal.

14. The method as claimed in claim 12, wherein the detecting unit detects a current direction passing the image input/output module to determine whether the signal is an output or input signal.

15. The method as claimed in claim 12, wherein the detecting unit further comprises a monitor unit, the monitor unit electrically connected to the control unit and the image input/output module.

16. The method as claimed in claim 12, wherein the detecting unit detects a state of an H/V sync of the signal to determine whether the signal is an output or input signal.

17. The method as claimed in claim 12, wherein the detecting unit comprises a logic unit, the logic unit electrically connected to the processing unit, the control unit and the image input/output module.

18. The method as claimed in claim 12, wherein the detecting unit further comprises a switch unit, the switch unit electrically connected to the control unit and used for switching to the input/output image.

19. The method as claimed in claim 12, wherein the detecting unit detects a connection status between the image input/output module and an external device to determine whether the signal is an output or input signal.

20. The method as claimed in claim 12, wherein the control unit is a south bridge chip or a keyboard controller.
